(19) United States
(12) Patent Application Publication
(10) Pub. No.: US 2011/0290637 A1
(43) Pub. Date: Dec. 1, 2011

(54) SENSING AND CONTROL FOR PLASMA-ASSISTED WASTE GASIFICATION

(75) Inventors: Aditya Kumar, Schenectady, NY (US); Matthew Christian Nielsen, Scotia, NY (US); Ruijie Shi, Clifton Park, NY (US)

(73) Assignee: GENERAL ELECTRIC COMPANY, SCHENECTADY, NY (US)

(21) Appl. No.: 12/790,531

(22) Filed: May 28, 2010

(51) Int. Cl. B01J 19/08; H05F 3/06

(52) U.S. Cl. 204/164; 422/186.04

(57) ABSTRACT

A plasma-assisted waste gasification system including a sensing mechanism and process for converting waste stream reaction residues into a clean synthesis gas (syngas) is disclosed. The gasification system includes a first sensor located between a gas quench unit and a heat recovery unit to measure a first temperature and first flow rate of the synthesis gas exiting the gas quench unit; a second sensor to measure a second temperature and a second flow rate of a low temperature synthesis gas entering the gas quench unit; wherein the first sensor and the second sensor are connected to an inferential sensing mechanism. The inferential sensing mechanism is capable of estimating the temperature of the synthesis gas in the reactor, based on the measured first temperature and first flow rate, and the measured second temperature and second flow rate, using a mass-energy balance relationship that is based on the measurements of the two sensors. Another aspect of the invention relates to a control unit to control the temperature of the reactor to a required operating temperature range.

This application claims the benefit of U.S. application Ser. No. 12/209011, filed Sep. 11, 2008, which claims the benefit of U.S. Provisional Application Ser. No. 60/971609, filed Sep. 12, 2007.

### BACKGROUND

Municipal waste is globally a growing problem. Landfills generate methane that is a green house gas concern. In addition, the tipping fees for landfills are increasing due to land constraints or governmentally mandated closures, which are in place in multiple countries, particularly in Asia and in the European Union, or will be in the near future. Incineration can be used, but this is sometimes not a good option for the future, due to environmental concerns.

Gasification is a process that converts carbonaceous materials, such as coal, petroleum, or biomass, into gases, such as carbon monoxide and hydrogen, by reacting the raw material at high temperatures with a controlled amount of oxygen. The resulting gas mixture is called synthesis gas or “syngas” and is in itself a fuel. Gasification is a very efficient method for extracting energy from many different types of organic materials, and also has applications as a clean waste disposal technique.

Generally, the gasification process consists of feeding carbon-containing materials into a heated chamber (the gasifier) along with a controlled and limited amount of oxygen and steam. At the high operating temperatures created by conditions in the gasifier, chemical bonds are broken by thermal energy and by partial oxidation, and inorganic mineral matter is fused or vitrified to form a molten glass-like substance called slag or vitreous frit. Any sensors placed inside the gasifier to monitor the temperature are exposed to very harsh environments, for example, very high temperatures and corrosive components. Hence, it is very difficult to directly measure the temperature of the gasifier, which is critical to ensure proper decomposition of all organics into syngas.

Waste gasification technology has been in development for the past few years, usually employing some form of gasification technology. Most gasifiers operate near atmospheric pressure, and require some energy in addition to the energy contained in the waste stream. Many gasifiers use coke, coal, natural gas or plasma arc torches to provide the additional energy. Utilizing a plasma arc torch to gasify a material is a technology that has been available commercially for many years. In most current designs, the plasma arc torch is placed near the bottom of the plasma arc reactor, with the plasma plume focusing on the slag or bed. Most plasma arc reactors produce a high quality syngas that can be used in other chemical manufacturing processes, or as a fuel for energy production.

Many feeds containing hydrocarbons, such as oil, coal, refinery residuals, and sewage sludge, have all been successfully used in gasification operations. It is sometimes desirable to convert a hazardous stream of material into a useable product by gasifying the material. Upon gasification, the hazardous material, or feed, will typically be converted into a useable syngas and a useful molten material, e.g., as slag or vitreous frit. Because the slag is in a fused, vitrified state, it is usually found to be non-hazardous, and may be disposed of in a landfill as a non-hazardous material, or sold as an ore, road-bed material, or other construction material. It is becoming less desirable to dispose of waste material by incineration, because of relatively low combustion efficiency, the potential pollution problem, and the need for further disposal of residual waste.

Typically, gasifiers are operated in an open-loop mode, where the oxygen and/or the plasma input is regulated, based on a priori information about the waste feedstock composition and flow rate. However, when the gasifier is operated in an open-loop mode, a constant gasifier temperature is not guaranteed, when the composition or the flow rate of the feedstock changes. In addition, pursuing a direct measurement of the gasifier temperature is very difficult, expensive and non-robust, owing to the high temperatures and harsh environment in the gasifier.

The sensors known in the art are usually unable to function in the harsh environment of the gasifier. Thus, other methods to estimate the gasifier temperature are necessary. Further, there exists a need for a process to control the fast variations (over seconds or minutes) and slow variations (over several minutes/hours/days) that may occur in gasifier temperatures. There is therefore a need for a robust operation of waste gasifiers in the presence of constant variations in waste feedstock, with controllable gasifier temperature conditions, and complete dissociation of all volatile organic compounds in the feedstock.

### BRIEF DESCRIPTION

One aspect of the present invention provides a plasma-assisted waste gasification system for converting a waste stream into a synthesis gas. The gasification system includes the following components: a reactor; a gas quench unit for partially cooling the synthesis gas from the reactor, a heat recovery unit located downstream of the gas quench unit to extract thermal energy; a scrubber located downstream of the heat recovery unit; and a first sensor located between the gas quench unit and the heat recovery unit. The first sensor is used to measure a first temperature and first flow rate of the synthesis gas exiting the gas quench unit. A second sensor, as further described below, is used to measure a second temperature and a second flow rate of a low temperature synthesis gas entering the gas quench unit. The first sensor and the second sensor are connected to an inferential sensing mechanism. The inferential sensing mechanism is capable of estimating the temperature of the synthesis gas in the reactor, based on the measured first temperature and first flow rate, and the measured second temperature and second flow rate, using a mass-energy balance relationship that is based on the measurements of the two sensors.

Another aspect the present invention provides a method of producing synthesis gas from a plasma-assisted waste gasification system. The method includes measuring the first temperature and the first flow rate of the synthesis gas exiting the gas quench unit; measuring the first temperature and the first flow rate of the synthesis gas exiting the gas quench unit, using the first sensor; measuring the second temperature and the second flow rate of synthesis gas recycled to the gas quench unit using, a second sensor; and estimating the temperature of the synthesis gas in the reactor, using the inferential sensing mechanism, based on the measured first temperature and first flow rate, and the measured second temperature and second flow rate, using a mass-energy balance relationship that is based on the measurements of the two sensors.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a section of a plasma-assisted gasification system, including a sensing mechanism according to an embodiment of the invention.

FIG. 2 is a schematic representation of a section of a plasma-assisted gasification system, including a sensing mechanism and a control unit according to another embodiment of the invention.

FIG. 3 is a schematic representation of the gasifier temperature control signals according to an embodiment of the invention.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention. In the specification and claims, reference will be made to a number of terms, which have the following meanings.

The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or may qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

“Optional” or “optionally” means that the subsequently described event or circumstance may or may not occur, and that the description includes instances where the event occurs and instances where it does not.

As noted, in one embodiment, the present invention provides a plasma-assisted waste gasification system for converting a waste stream into a synthesis gas. The gasification system includes a reactor, usually (though not always) having three zones: a bottom zone for melting the waste stream reaction residues and forming a slag pool; a middle zone for converting the waste stream into the synthesis gas; and a top zone having at least one plasma arc torch for controlling temperature of the synthesis gas in the gasifier. The gasification system includes a gas quench unit for partially cooling the synthesis gas from the reactor, a heat recovery unit located downstream of the gas quench unit to extract thermal energy; a scrubber located downstream of the heat recovery unit; a first sensor located between the gas quench unit and the heat recovery unit; and a second sensor located between the scrubber and the gas quench unit. The first sensor and the second sensor are connected to an inferential sensing mechanism. The first sensor is used to measure a first temperature and first flow rate of the synthesis gas exiting the gas quench unit. The second sensor is used to measure a second temperature and a second flow rate of a low temperature synthesis gas entering the gas quench unit. The inferential sensing mechanism is capable of estimating the temperature of the synthesis gas in the reactor, based on the measured first temperature and first flow rate, and the measured second temperature and second flow rate, using a mass-energy balance relationship that is based on the measurements of the two sensors.

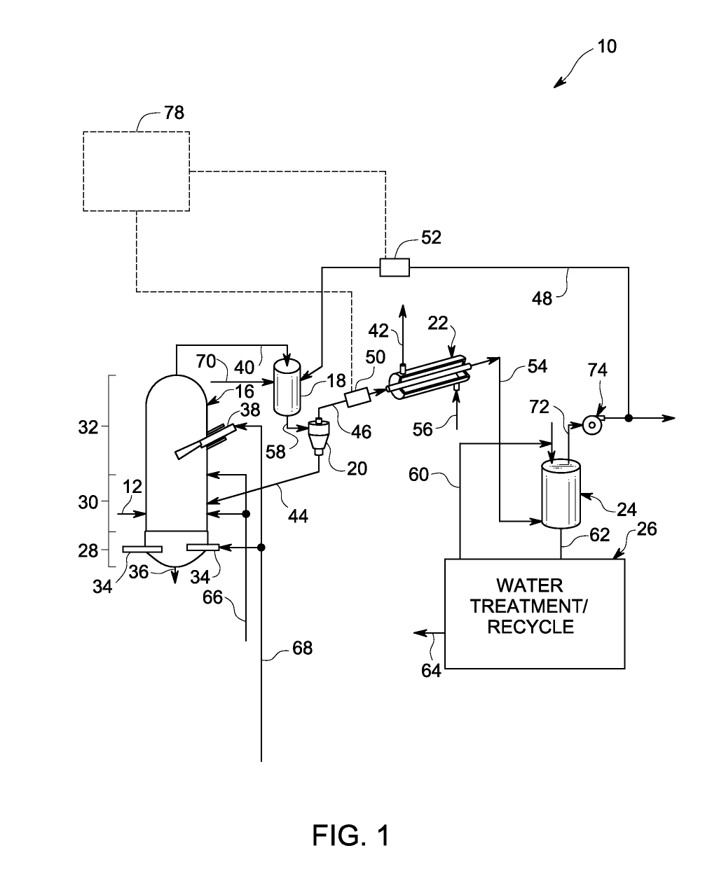

Referring to the drawings, identical reference numerals denote the same elements throughout the various views. A schematic representation of a plasma-assisted waste gasification system (10) according to one embodiment of the invention is shown in FIG. 1. The plasma-assisted waste gasification system, shown generally at 10, converts a waste stream into a synthesis gas (syngas). This type of system is generally described in the above-referenced, pending patent application, Ser. No. 12/209011, which is incorporated herein by reference. In general, the system 10 includes, but is not limited to, a waste handling facility, a pre-heater unit, a gasification reactor (gasifier) 16, a gas quench 18, a cyclone 20, a heat recovery unit 22, a scrubber 24, and a water treatment/recycle unit 26. Other possible units and equipment not specifically shown in the drawing include a mercury removal unit, a sulfur removal unit, a surge/buffer vessel, electrical power generation equipment (which may include one or more units), and an air separation unit (ASU).

As described in the U.S. patent application Ser. No. 12/209011, which is incorporated herein by reference, the municipal solid waste (MSW) that may include, for example, plastics, tires, wet organic waste, and the like, enters the waste handling facility for recycling, screening and/or shredding. In one embodiment, the waste stream 12 is fed into the reactor 16 (which may be pressurized), from the bottom of the reactor, through the use of one or more feed mechanisms, as described in the U.S. patent application Ser. No. 12/209011.

In one embodiment, the reactor (also referred to as the “gasification reactor” or “gasifier”) 16 may be made of high-grade steel. Depending upon design criteria, the entire reactor 16 may be water-cooled by various methods, as described in Ser. No. 12/209011. As shown in FIG. 1 the gasification reactor 16 can be divided into three reacting zones: a bottom zone 28 for melting the waste stream reaction residues and forming a slag pool, a middle zone 30 for converting the waste stream into the synthesis gas, and a top zone 32 having at least one plasma arc torch for controlling the temperature and composition of the synthesis gas. In one embodiment, the reactor 16 may be funnel shaped, which may help reduce the gas velocity, increase the residence time inside the reactor; and decrease the potential for entrainment of particulate matter. The bottom zone 28 of the reactor 16 is referred to as a melting zone, in which melting of the reaction residues of the waste stream 12 occurs, and a slag pool forms with glass and metal layers. In one embodiment, the bottom zone 28 includes one or more Joule/plasma heating devices 34 (FIG. 1) that can provide thermal energy to the melt, to maintain the slag at a high temperature, for example, about 1400° C. The slag pool exits the reactor 16 through line 36, where the molten slag liquid is tapped continuously into a moving granulating water bath (not shown), cooled and vitrified into an inert slag material suitable for re-use as construction material, for example, tiles, roofing granules, bricks, and the like.

The middle zone 30 of the reactor 16 is referred to as a gasification zone, in which organics are converted to synthesis gas (syngas). It should be appreciated that some portion of the gasification reactions may also occur in the bottom zone 28. In the illustrated embodiment, the waste stream 12 enters through a single feed mechanism (FIG. 1). The middle zone 30 may include one or more heating devices, such as an oxygen lance, a plasma arc torch, and the like. In one embodiment, the heating devices are fed oxygen, oxygen-enriched air, steam or carbon dioxide (as pre-determined according to the waste composition), which is introduced into the reactor 16 through lines (or pipes) from the air separation unit, to further assist in char gasification.

The top zone 32 of the reactor 16 is referred to as a plasma temperature controlled zone, in which the temperature of the zone is controlled, and the synthesis gas (syngas) is polished. As used herein, the term “polishing” of the synthesis gas is defined as the complete conversion from hydrocarbons to synthesis gas, and the destruction of toxic compounds. The top zone 32 may include one or more integrated heating devices 38, such as plasma arc torches. In another embodiment, the heating devices 38 comprise plasma gas torches that are supplied with oxygen, oxygen enriched air, steam or carbon dioxide. The oxygen to fuel ratio in the gasifier is typically in a range of about 0.5 to about 1.5.

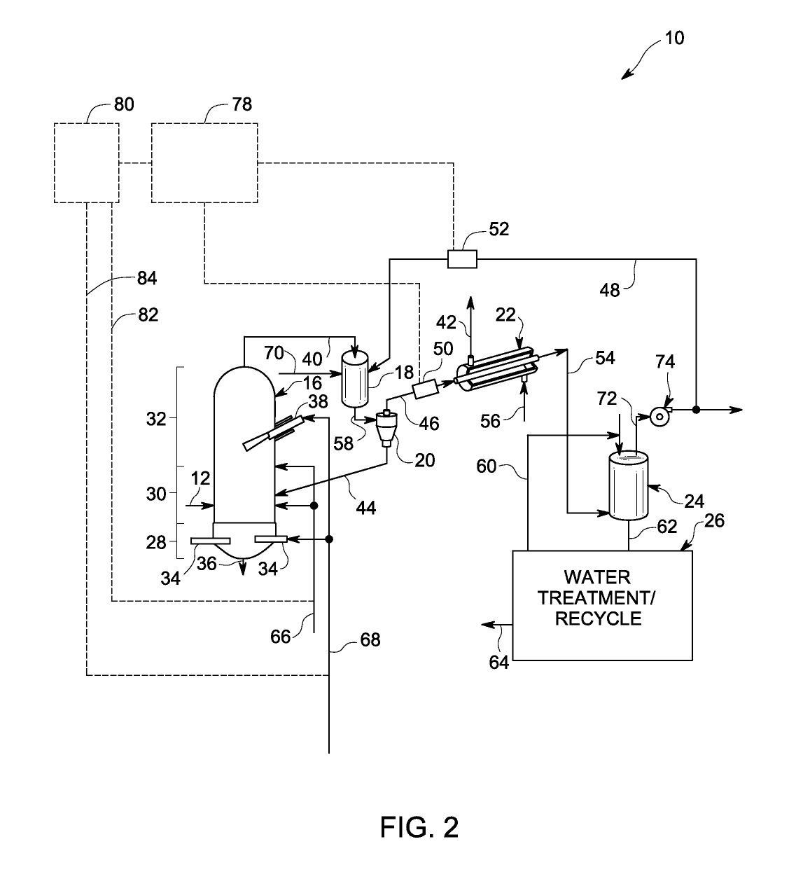

In one embodiment, the plasma torch 38 (FIG. 2) may be mounted in a tuyere-like attachment (not shown), which is typically made of water-cooled copper. As described in application Ser. No. 12/209011, multiple tuyere attachments can be equally spaced around the circumference of the reactor 16. The number of plasma torches, the power rating of each torch, the capacity of the waste feeding system, the amount of carbon catalyst, the amount of flux, the size of the reactor, the size and capacity of the syngas cleaning system; and the size of the combined cycle gas turbine system; are all variables that may be determined according to the type and volume of waste to be processed by the system.

In one embodiment, the synthesis gas (syngas) in the top zone 32 of the reactor 16 (FIG. 2) has a temperature of between about 1200 to about 1500° C. In the illustrated embodiment, the hot syngas exits the reactor 16 through a single outlet in the center of the top of the reactor 16. In another embodiment, the reactor may have a plurality of exit gas outlets around the top of the reactor 16. The gasification system can include a gas quench unit 18 for partially cooling the syngas from the reactor. In one embodiment depicted in FIG. 1, the hot syngas from the reactor 16 enters the gas quench unit 18 through line 40, which cools the hot syngas to a temperature of about 800° C. In another embodiment, the relatively cooler syngas from the gas quench unit 18 enters the cyclone 20 through line 58, which separates the particulates from the cooler syngas. The particulates from the cyclone 20 may return to the feed mechanism of the reactor 16 through line 44.

In some preferred embodiments depicted in FIG. 1, the gasification system further includes a heat recovery unit 22 which is located downstream of the gas quench unit 18. The heat recovery unit may be employed to extract thermal energy. In one embodiment, the relatively cooler syngas, with the particulates removed, enters the heat recovery unit 22 through line 46. In some situations, the gas quench unit 18 cools the hot syngas by using cold syngas at a temperature of about 50° C., that has been recycled from the scrubber 24 through line 48. Alternative heat exchange fluids, such as natural gas, N₂, and the like, can be used to quench the hot syngas upon startup of the gasification system 10, when there is insufficient cool syngas available from the scrubber 24. The partially quenched syngas allows for the recovery of the heat from the heat recovery unit 22, which is used to generate steam and/or to preheat the waste stream 12, thereby increasing the overall efficiency of the gasification system 10. This can be contrasted with some of the conventional systems that use either an acid quench or a water quench at near-ambient temperature.

The gasification system of the present invention further includes a first sensor 50 and a second sensor 52. As used herein the term “first sensor” and “second sensor” may also refer to a set of sensors for temperature and flow measurement, or may be alternatively referred to as a “sensing set”. The first sensor 50 is located between the gas quench unit 18 and the heat recovery unit 22. In one embodiment, the first sensor 50 may be located either upstream or downstream of the cyclone 20. In another embodiment, the first sensor 50 is positioned at another location between the gas quench unit 18 and the cyclone 20. In yet another embodiment, the first sensor 50 is located between the cyclone 20 and the heat recovery unit 22. In another embodiment, the first sensor 50 is located between the heat recovery unit 22 and the scrubber 24.

The second sensor 52 is employed to measure the temperature and flow rate of the low temperature gas feed into the gas quench system. In one embodiment, the second sensor 52 is located between the scrubber 24 and the gas quench unit 18. In another embodiment, the second sensor 52 is located on the line 48 wherein the cold syngas is recycled. In another embodiment, the second sensor 52 may be located on a gas stream that is extracted from the main synthesis gas stream after the heat recovery unit 22. In yet another embodiment, the second sensor 52 may be located at some other location between the heat recovery unit 22 and the gas quench unit 18. Those skilled in the art may conceive of other suitable locations where the second sensor 52 may be located, based on the varying sensor and gasification system design.

In one embodiment, the first sensor and the second sensor include flow sensors and temperature sensors, and may be employed to measure the temperature and the flow rate of the synthesis gas. Non-limiting examples of the sensors include thermocouples, optical pyrometers, fiber optic sensors, resistive thermal devices for measuring gas temperature, an orifice plate, a venturimeter, an ultrasonic flowmeter for measuring gas flow rates, and the like.

In one embodiment, the gasification system further includes an air separation unit. This unit can include an air intake site for a compressor that pressurizes the air, e.g., to about 3 atmospheres. The pressurized air is then fed through packed columns that remove other gases from the air, such as N₂. The resulting stream can contain about 95% O₂, and may be introduced into the gasifier 16.

As mentioned above, the harsh environment in the gasifier 16 precludes a direct measurement of gasifier temperature. In one embodiment, the present invention estimates the gasifier temperature through indirect measurements downstream of the gasifier 16, where the operating conditions are more amenable to direct measurement. In one embodiment, the temperature of the syngas downstream of the gasifier 16 may be measured using the first sensor 50 and the second sensor 52. In one embodiment, the first sensor 50 is used to measure a first temperature and first flow rate of the synthesis gas 58 exiting the gas quench unit. In another embodiment, the first sensor 50 is used to measure a temperature and flow rate of the synthesis gas 46 exiting the cyclone 20. The second sensor 52 is used to measure a second temperature and a second flow rate of a low temperature synthesis gas 48 entering the gas quench unit. As used herein the term “low temperature synthesis gas” refers to the relatively cooler synthesis gas at a temperature of about 50° C., that has been recycled from the scrubber 24 through line 48, to the gas quench unit 18. The first sensor 50 and the second sensor 52 are connected to an inferential sensing mechanism 78. In one embodiment, the inferential sensing mechanism 78 and the sensors 50, 52 may be present in the same location. In another embodiment, the inferential sensing mechanism 78 and the sensors 50, 52 may be present at a distance apart from each other, as illustrated in FIG. 1. Using the mass-energy balance relationship, the inferential sensing mechanism is capable of estimating the temperature of the synthesis gas in the reactor, based on the measurements of the two sensors 50, 52, and which is based on the measured first temperature and first flow rate, and the measured second temperature and second flow rate.

An illustration of the use of the mass energy balance model can be described. With reference to FIG. 1, the first sensor 50 can measure the temperature (T₂) of the gas stream 46 exiting the cyclone 20, while the second sensor 52 can measure the temperature (T₃) of the cooled syngas stream 48 that enters the gas quench unit 18. Flow sensors included in the first sensor 50 and the second sensor 52 are used to measure the flow rate (F₂) of the gas stream 46 exiting the cyclone 20, and the flow rate (F₃) of the cooled syngas stream 48 that enters the gas quench unit 18, respectively. An orifice flow meter or a thermal flow meter can be used to measure the F₂ and F₃ values. The variables that can be measured are as follows:
Temperature of gas stream 46 that exists the cyclone 20 (T₂);
Temperature of the cooled syngas stream 48 that enters the gas quench unit 18 (T₃);
Flow rate of the gas stream 46 that exits the cyclone 20 (F₂); and
Flow rate of the cooled syngas stream 48 that enters the gas quench unit 18 (F₃)

Using a steady-state condition, the mass and energy balance equations are as follows:

Mass balance: F₃=F₂+F₁ Eq. (1)

Energy balance: F₃Cₚ(T₃)(T₃−T_{ref})=F₂Cₚ(T₂)(T₂−T_{ref})+F₁Cₚ(T₁)(T₁−T_{ref}) Eq. (2)

wherein Cₚ is the specific heat capacity of syngas as a function of temperature.

The data for downstream flow rates and temperature measurements were combined to estimate the flow rate (F₁) and temperature (T₁) of the syngas 40 from the reactor. For example, for a plant capacity of about (˜2000 tons per day MSW feed), the flow rates and the temperature measured by the sensors 50 and 52 can be as follows:

F₂=35 kg/s, F₃=70 kg/s

T₂=50° C., T₃=800° C.

Therefore by using the above mass energy balance equation the estimated flow rate (F₁) and temperature (T₁) of the syngas 40 from the reactor 16 can be determined as follows, wherein the specific heat capacity Cₚ is assumed to be a constant for simplicity:

F₁=35 Kg/s and T₁=1550° C.

In another embodiment, the present invention is related to a method of estimating the gasifier temperature, and employing a control system to control the gasifier temperature.

Optimization and control of the gasifier temperature is important to facilitate a stable and high performance operation of the gasification system. However, many disturbances such as variations in the flow rate, temperature and compositions (including the moisture content) of the waste feed stream 12 etc., may affect the gasifier temperature. In one embodiment, the gasification system of the present invention may further include a control unit 80 (FIG. 2). The control unit 80 may utilize the estimated gasifier temperature obtained from the inferential sensing mechanism 78, to stabilize the gasifier temperature to a set-point that enables conversion of almost all of the hydrocarbons and potential toxic compounds into syngas. In another embodiment, the gasifier temperature may be controlled by adjusting the power of the plasma torch 38. In another embodiment, the gasifier temperature may be controlled by adjusting the oxygen flow-rate to optimize the oxygen-to-fuel ratio for a given situation. In one embodiment, the gasifier temperature may be controlled by varying both the power to the plasma torch and the oxygen flow rate, to adjust the oxygen-to-fuel ratio. By doing so, the overall temperature or energy flux into the reactor 16, and the composition(s) of the syngas, can be controlled, as compared to conventional reactors in which the plasma torches are focused on the slag at the bottom of the reactor.

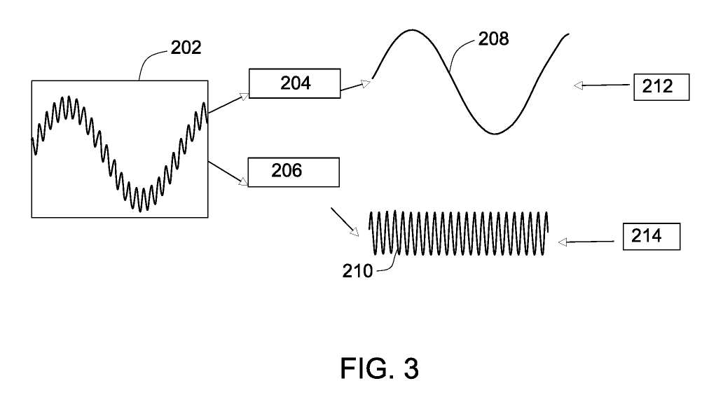

In one embodiment, as illustrated in FIG. 3, the estimated gasifier temperature reading 202 is found to have variations in fast (seconds/minutes) and slow (minutes/hours/days) time-scales. In one embodiment, a suitable low-pass filter 204, and a high-pass filter 206, may be employed to identify and separate these slow variations 208 and fast variations 210, that may be present in the gasifier temperature. In one embodiment, the control unit 80 (FIG. 2) may adjust the plasma power to mitigate the impact of any changes in the feed (e.g. a sudden increase in moisture content) on the gasifier temperature, i.e. the variations in the fast time-scales 84 (as designated in FIG. 2). In another embodiment, the control unit 80 (FIG. 2) may adjust the oxygen flowrate to mitigate the impact of any changes in the gasifier temperature due to the variations in the slow time-scales 82 (as designated in FIG. 2), e.g., due to waste stream temperature variations with day-evening schedules and cycles. In one embodiment, the slow variation 208 and fast variations 210 may be used by control algorithms, such as conventional PID control, to adjust the oxygen flow rate to the gasifier, and to adjust the plasma power respectively. In one embodiment, the flowrate of oxygen (or in some cases air or enriched air) may be varied to adjust the oxygen-to-fuel ratio between about 0.5 and about 1.5, and to control the gasifier temperature. In another embodiment, the control unit 80 may adjust both the plasma power and the oxygen flow rate, so as to adjust the gasifier temperature to a required operating temperature range.

In one embodiment, the reactor 16 (FIG. 1) may contain sensors (not shown) to detect the pressure inside the reactor, as well as gas sampling ports and appropriate gas analysis equipment (not shown), at strategic positions in or just after the reactor 16, to monitor the gasification process.

Referring back to FIG. 1 the syngas exits the heat recovery unit 22 at a relatively low temperature, for example, about 110° C., through line 54, and enters the scrubber 24. In one embodiment, the scrubber 24 cools the syngas to a low temperature, for example about 50° C., and may scrub out solid particulates in the synthesis gas using water through line 60, from the water treatment/recycle unit 26. In another embodiment, the water with the particulates that exits the scrubber 24 through line 62 may be recycled back to the water treatment/recycle unit 26. Any particulates (fines) in the water may be removed by the water treatment/recycle unit 26, and returned to the feed mechanism of the reactor 16 through line 64 (shown as an arrow in the figure).

In one embodiment, a method of producing synthesis gas from the plasma-assisted waste gasification system of the present invention is provided. The method includes measuring the temperature and flow rate of synthesis gas downstream of the gas quench unit; measuring the temperature and flow rate of synthesis gas recycled to the gas quench unit; and estimating temperature and flow rates of synthesis gas at the reactor outlet. In one embodiment, the method further includes controlling the power to a plasma torch, based on the estimated temperature of synthesis gas at the reactor outlet. In another embodiment, the method includes controlling the oxygen flow-rate to the reactor, based on the same temperature estimate.

While the invention has been described with reference to exemplary embodiments, it will be understood by those skilled in the art that various changes may be made, and equivalents may be substituted for elements thereof, without departing from the scope of the invention. In addition, many modifications may be made to adapt a particular situation or material to the teachings of the invention, without departing from the essential scope thereof. Therefore, it is intended that the invention not be limited to the particular embodiment disclosed as the best mode contemplated for carrying out this invention, but that the invention will include all embodiments falling within the scope of the appended claims.

1. A plasma-assisted waste gasification system for converting a waste stream into a synthesis gas, comprising the following components:
a reactor;
a gas quench unit for partially cooling the synthesis gas from the reactor,
a heat recovery unit located downstream of the gas quench unit to extract thermal energy;
a scrubber located downstream of the heat recovery unit;
a first sensor located between the gas quench unit and the heat recovery unit to measure a first temperature and first flow rate of the synthesis gas exiting the gas quench unit;
a second sensor to measure a second temperature and a second flow rate of a low temperature synthesis gas entering the gas quench unit; wherein the first sensor and the second sensor are connected to an inferential sensing mechanism; and
wherein the inferential sensing mechanism is capable of estimating the temperature of the synthesis gas in the reactor, based on the measured first temperature and first flow rate, and the measured second temperature and second flow rate, using a mass-energy balance relationship that is based on the measurements of the two sensors.

2. The system of claim 1, wherein the reactor comprises three zones; a bottom zone for melting the waste stream reaction residues and forming a slag pool, a middle zone for converting the waste stream into the synthesis gas, and a top zone having at least one plasma arc torch for controlling a temperature of the synthesis gas and composition of the synthesis gas.

3. The system of claim 1, further comprising a cyclone located downstream from the gas quench unit.

4. The system of claim 3, wherein the first sensor is located between the gas quench unit and the cyclone.

5. The system of claim 3, wherein the first sensor is located between the gas cyclone and the heat recovery unit.

6. The system of claim 1, wherein the second sensor is located between the scrubber and the gas quench unit.

7. The system of claim 1, wherein the first sensor and the second sensor comprise flow sensors and temperature sensors.

8. The system of claim 1, wherein the first sensor and the second sensor comprise sensors selected from thermocouples, optical pyrometers, fiber optic sensors, resistive thermal device, orifice plate, venturimeter, ultrasonic flowmeter and combinations thereof.

9. The system of claim 1, wherein the inferential sensing mechanism estimates the temperature of the synthesis gas in the reactor, based on measurements of temperatures and flow rates downstream of the reactor.

10. The system of claim 9, wherein the at least one plasma arc torch is adjusted in real- time, to control the temperature of the synthesis gas in the reactor.

11. The system of claim 1, further comprising an air separation unit for providing oxygen to the reactor.

12. The system of claim 1, further comprising a control unit to control the temperature of the reactor.

13. The system of claim 1, further comprising a power generation unit.

14. A method of producing synthesis gas from a plasma-assisted waste gasification system comprising the following components:
a reactor;
a gas quench unit for partially cooling the synthesis gas from the reactor,
a heat recovery unit located downstream of the gas quench unit to extract thermal energy;
a scrubber located downstream of the heat recovery unit;
a first sensor located between the gas quench unit and the heat recovery unit; to measure a first temperature and first flow rate of the synthesis gas exiting the gas quench unit;
a second sensor to measure a second temperature and a second flow rate of a low temperature synthesis gas entering the gas quench unit; wherein the first sensor and the second sensor are connected to an inferential sensing mechanism;
the method comprising:
measuring the first temperature and the first flow rate of the synthesis gas exiting the gas quench unit;
measuring the second temperature and the second flow rate of synthesis gas recycled to the gas quench unit; and
estimating the temperature of the synthesis gas in the reactor, using the inferential sensing mechanism, based on the measured first temperature and first flow rate, and the measured second temperature and second flow rate, using a mass-energy balance relationship that is based on the measurements of the two sensors.

15. The method of claim 14, further comprising controlling the temperature of the synthesis gas in the reactor, using a control unit.

16. The method of claim 14, further comprising controlling the power to the plasma torch, based on said estimated temperature of synthesis gas at the reactor outlet.

17. The method of claim 14, further comprising controlling the oxygen flow rate to the reactor, based on said estimated temperature of the synthesis gas at the reactor outlet.
